(19) United States
(12) Patent Application Publication
(10) Pub. No.: US 2020/0208925 A1
(43) Pub. Date: Jul. 2, 2020

(54) SHUTTER STRUCTURE OF HEAT EXCHANGER FOR VEHICLE

(71) Applicant: DENSO CORPORATION, Kariya-city (JP)

(72) Inventors: Yukio SHIDARA, Kariya-city (JP); Akihiro MAEDA, Kariya-city (JP)

(21) Appl. No.: 16/814,609

(22) Filed: Mar. 10, 2020

Related U.S. Application Data
(63) Continuation of application No. PCT/JP2018/030828, filed on Aug. 21, 2018.

(30) Foreign Application Priority Data
Oct. 12, 2017 (JP) 2017-198278

(51) Int. Cl. F28F 13/06; F28D 1/02; B60K 11/08

(52) U.S. Cl. CPC F28F 13/06; F28D 1/024; B60K 6/22; F28F 2265/02; B60K 11/085

(57) ABSTRACT

A shutter structure of a heat exchanger for a vehicle includes a screen and a screen winding unit. The screen is arranged on a front side or a rear side of the heat exchanger. The screen winding unit is capable of moving the screen with respect to the heat exchanger by winding the screen. An opening is formed in a part of the screen.

### CROSS-REFERENCE TO RELATED APPLICATION

The present application is a continuation application of International Patent Application No. PCT/JP2018/030828 filed on Aug. 21, 2018, which designated the U.S. and claims the benefit of priority from Japanese Patent Application No. 2017-198278 filed on Oct. 12, 2017. The entire disclosures of all of the above applications are incorporated herein by reference.

### TECHNICAL FIELD

The present disclosure relates to a shutter structure of a heat exchanger for a vehicle.

### BACKGROUND

A shutter is provided on a heat exchanger in order to adjust a ventilation amount to the heat exchanger.

### SUMMARY

According to an aspect of the present disclosure, a shutter structure of a heat exchanger for a vehicle includes: a screen arranged on a front side or a rear side of the heat exchanger; and a screen winding unit capable of moving the screen with respect to the heat exchanger by winding the screen. An opening is formed in a part of the screen.

### BRIEF DESCRIPTION OF DRAWINGS

FIG. 1 is a perspective view illustrating a cooling device for a vehicle according to a first embodiment.

FIG. 2 is a front view of a heat exchanger of the first embodiment.

FIG. 3 is a side view of the cooling device of the first embodiment.

FIG. 4 is a perspective view of a screen of the first embodiment.

FIG. 5 is front views of the heat exchanger and the screen of the first embodiment.

FIG. 6 is a front view of the heat exchanger of the first embodiment and a front view of a screen of a modification of the first embodiment.

FIG. 7 is a diagram illustrating use states of the cooling device of the first embodiment.

FIG. 8 is a diagram illustrating use state of the cooling device of the first embodiment.

FIG. 9 is a front view illustrating a blower according to a second embodiment.

FIG. 10 is a front view illustrating a part of a screen of the second embodiment.

### DESCRIPTION OF EMBODIMENTS

To begin with, examples of relevant techniques will be described.

A shutter is provided to a heat exchanger for a vehicle in order to adjust a ventilation amount of the heat exchanger. For example, a grill shutter includes plural blades arranged in parallel, and a motor opens or closes the blades.

However, when the blades are opened or closed by one motor, all the blades are simultaneously opened or closed at the same angle. In this case, it is not possible to open only some of the blades.

In a hybrid vehicle or a vehicle equipped with a water-cooled intercooler, plural cooling circuits are provided. Two radiators may be stacked in a two-tiered manner in the vertical direction. If the above-described shutter is used for the stacked radiators, it is not possible to cool only a portion of the stacked radiators. In this case, plural motors for opening or closing the blades are required in order to open some of the blades.

Further, if the chance of opening the shutter increases, the amount of air passing through the heat exchanger increases. As a result, a situation where the Cd value can be reduced decreases.

The present disclosure provides a shutter structure that can cool only a necessary portion of a heat exchanger with a simple configuration.

In one aspect of the present disclosure, a shutter structure of a heat exchanger for a vehicle includes: a screen arranged on a front side or a rear side of the heat exchanger; and a screen winding unit capable of moving the screen with respect to the heat exchanger by winding the screen. An opening is formed in a part of the screen.

Accordingly, the screen can be moved by one driving unit by using the roll-type shutter structure for winding the screen. In addition, by providing an opening in a part of the screen, only a part of the plural heat exchangers or only a part of one heat exchanger can be appropriately cooled. Thus, only a necessary portion of the heat exchanger can be cooled with a simple configuration.

### First Embodiment

A first embodiment will be described. A cooling device for a vehicle of the present embodiment is mounted on a hybrid vehicle that obtains driving force for traveling from an engine and an electric motor. The driving force of the engine is used not only for driving the vehicle but also for operating the generator. The electric power generated by the generator can be stored in the battery. DC power output from the battery is converted into AC power by an inverter and supplied to the motor.

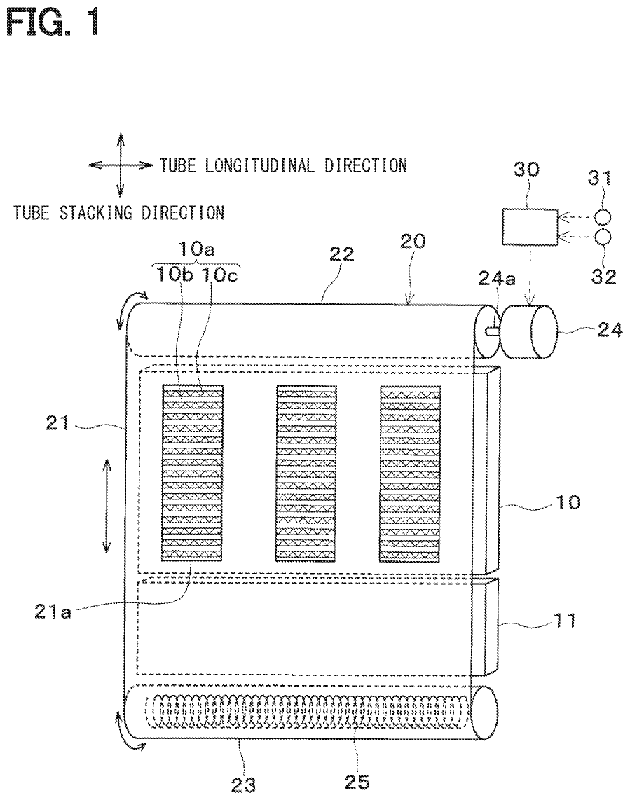

As shown in FIG. 1, the cooling device of the present embodiment includes a first heat exchanger 10, a second heat exchanger 11, and a shutter device 20. In FIG. 1, the front side corresponds to a front side of the vehicle, and the rear side corresponds to a rear side of the vehicle. Although not shown in FIG. 1, a blower is provided on the rear side of the heat exchanger 10, 11. Outside air is blown to the heat exchanger 10, 11 by the blower.

The heat exchanger 10, 11 of the present embodiment is a radiator in which heat is exchanged between cooling water (heat exchange medium) and outside air to cool the cooling water. In the present embodiment, the plural heat exchangers 10 and 11 are provided, and a cooling water flowing through the heat exchanger 10 is different from a cooling water flowing through the heat exchanger 11.

The cooling device according to the present embodiment has plural cooling water circuits, such as an engine cooling water circuit in which engine cooling water circulates, and an inverter cooling water circuit in which inverter cooling water circulates. The first heat exchanger 10 is provided in the engine cooling water circuit, and the engine cooling water flows through the first heat exchanger 10. The second heat exchanger 11 is provided in the inverter cooling water circuit, and the inverter cooling water flows through the second heat exchanger 11. That is, the cooling water flows through the heat exchanger 10 from a first system, and the cooling water flows through the heat exchanger 11 from a second system different from the first system.

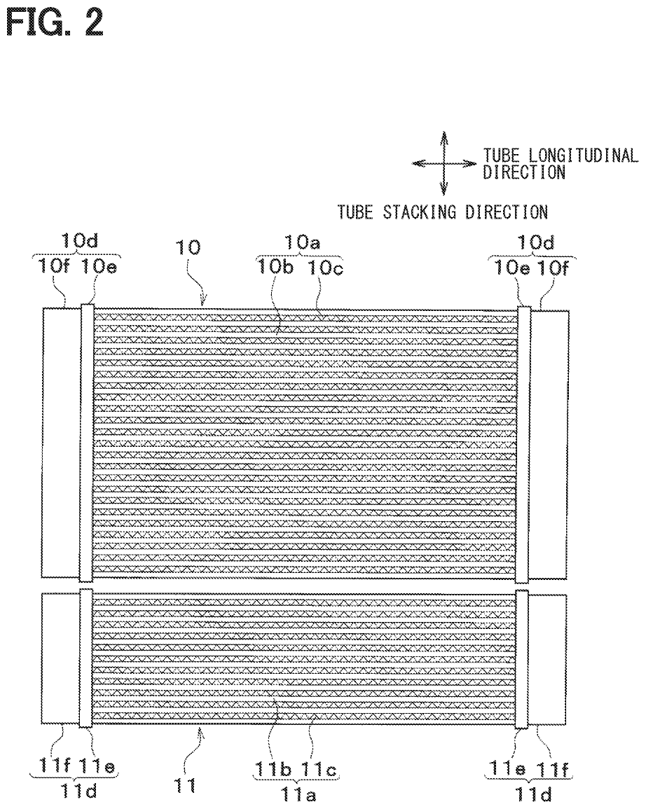

Since the first heat exchanger 10 and the second heat exchanger 11 have the same configuration, only the configuration of the first heat exchanger 10 will be described. As shown in FIG. 2, the first heat exchanger 10 has a core portion 10a and header tanks 10d arranged at both ends of the core portion 10a.

The core potion 10a includes a tube 10b and a fin 10c. The tube 10b is a tubular member through which cooling water flows. The plural tubes 10b are arranged in parallel. In the present embodiment, the tubes 10b are arranged such that the longitudinal direction of the tube 10b is the horizontal direction, and the stacking direction of the tubes 10b is the vertical direction. The fin 10c is joined between the adjacent tubes 10b, to increase the heat transfer area, such that heat exchange is facilitated between the cooling water and air.

The header tank 10d communicates with the tubes 10b at both ends of the tube 10b. The header tank 10d has a core plate 10e into which the tube 10b is inserted and joined, and a tank body 10f that forms a tank space together with the core plate 10e.

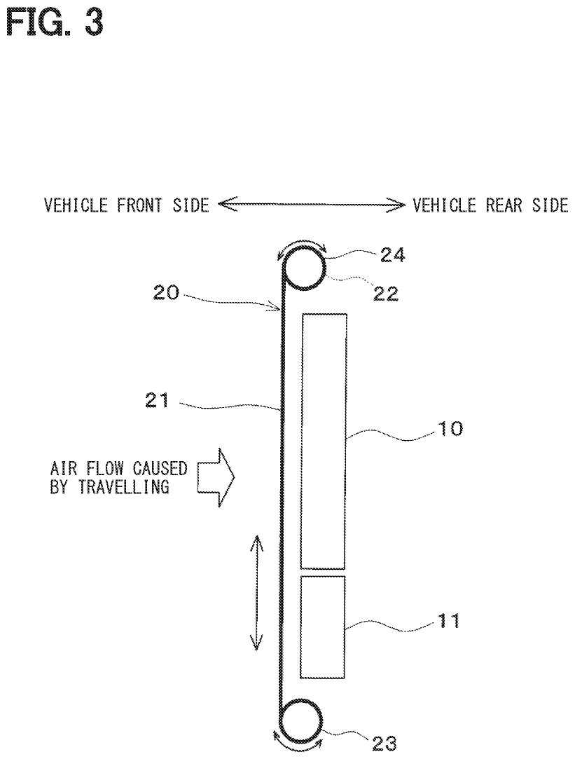

As shown in FIGS. 1 to 3, the first heat exchanger 10 and the second heat exchanger 11 are arranged in a stacked manner. The tube stacking direction of the first heat exchanger 10 is the same as that of the second heat exchanger 11. In the present embodiment, the first heat exchanger 10 is arranged on the upper side and the second heat exchanger 11 is arranged on the lower side in the vertical direction. The first heat exchanger 10 and the second heat exchanger 11 are arranged not to overlap with each other in the front-rear direction of the vehicle.

As shown in FIG. 1, the shutter device 20 includes a screen 21. The screen is a sheet-like member having flexibility and is made of, for example, a fluororesin sheet. In the present embodiment, the screen 21 is disposed to cover at least the core portion 10a, 11a of the heat exchanger 10, 11.

The shutter device 20 can adjust the ventilation amount of the heat exchangers 10 and 11 by moving the screen 21 with respect to the heat exchangers 10 and 11. In the present embodiment, the screen 21 is movable in the vertical direction.

The shutter device 20 of the present embodiment has a roll-type structure in which the screen 21 can be moved by winding the screen 21. In the present embodiment, a first winding unit 22 and a second winding unit 23 are provided at both ends of the screen 21. The first winding unit 22 is provided at an upper end of the screen 21, and the second winding unit 23 is provided at a lower end of the screen 21. The first winding unit 22 is located above the first heat exchanger 10, and the second winding unit 23 is located below the second heat exchanger 11. The first winding unit 22 and the second winding unit 23 correspond to a screen winding unit.

A rotating shaft 24a of the motor 24 is connected to the first winding unit 22. The motor 24 is a driving unit that drives the first winding unit 22 to rotate. By operating the motor 24, the first winding unit 22 can be rotated. The motor 24 can rotationally drive the first winding unit 22 in a direction in which the screen 21 is wound and a direction in which the screen 21 is sent out.

The second winding unit 23 has a spring member 25 such as a torsion spring. The spring member 25 causes a spring force to act on the second winding unit 23 in a direction in which the screen 21 is wound.

When the motor 24 is operated to wind the screen 21 around the first winding unit 22, the screen 21 can be moved in a direction from the second winding unit 23 to the first winding unit 22. The screen 21 can be stopped by stopping the rotation of the motor 24. The screen 21 can be moved in a direction from the first winding unit 22 to the second winding unit 23 by operating the motor 24 so as to send out the screen 21 from the first winding unit 22.

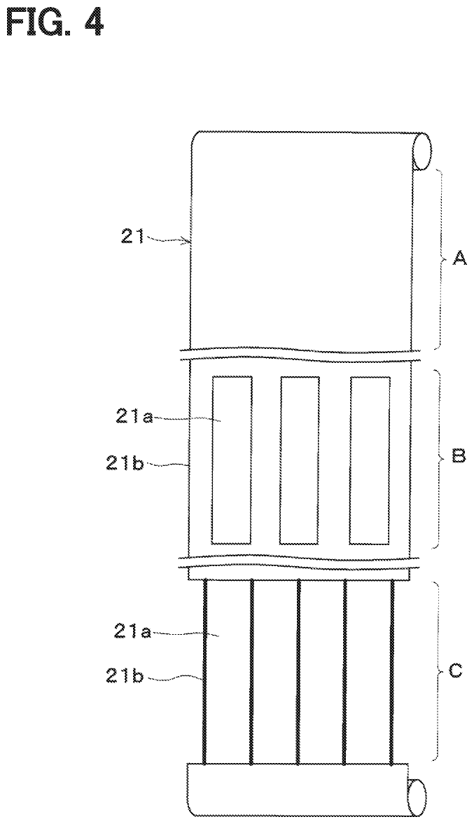

As shown in FIG. 4, an opening 21a is formed in a part of the screen 21. The opening 21a is a hole open in a part of the sheet surface. A portion of the screen 21 where the opening 21a is formed has a connecting portion 21b by which the sheet surfaces are connected with each other. The opening 21a has plural opening patterns different in the opening modes such as an opening area, an opening position, and an opening shape.

Outside air that has passed through the opening 21a of the screen 21 is supplied to the heat exchangers 10 and 11. The position of the opening 21a with respect to the heat exchangers 10 and 11 is changed by moving the screen 21 with respect to the heat exchangers 10 and 11, to control the amount of air flowing through the heat exchangers 10 and 11.

In addition, the amount of air passing through the opening 21a can be controlled by controlling the opening area of the opening 21a. Thus, the amount of air flowing through a part of the heat exchangers 10 and 11 corresponding to the opening 21a can be adjusted. The opening area, the opening position, the opening shape, and the like of the opening 21a can be suitably set, according to the needed cooling amount of the heat exchanger 10, 11. The needed cooling amount of the heat exchanger 10, 11 can be rephrased as a required ventilation amount to the heat exchanger 10, 11. The opening 21a may be optimized for each vehicle on which the cooling device is mounted.

The screen 21 has plural regions such as a closed region A, an intermediate open region B, and a maximum open region C, which are different in the number of the openings 21a and/or the opening area of the opening 21a.

The closed area A has no opening 21a. In other words, the sheet surface of the screen 21 is present on the entire surface, such that outside air does not pass through the heat exchangers 10 and 11. The intermediate open area B and the maximum open area C have the opening 21a, such that outside air passes through the heat exchangers 10 and 11.

The opening pattern of the opening 21a is different between the intermediate open area B and the maximum open area C. Specifically, the opening area of the opening 21a is larger in the maximum open area C than in the intermediate open area B. For this reason, the ventilation volume of the heat exchanger 10, 11 is larger in the maximum open area C than in the intermediate open area B. In FIG. 4, in the maximum open area C, the connecting portion 21b has a string shape, and the opening area of the opening 21a is maximized.

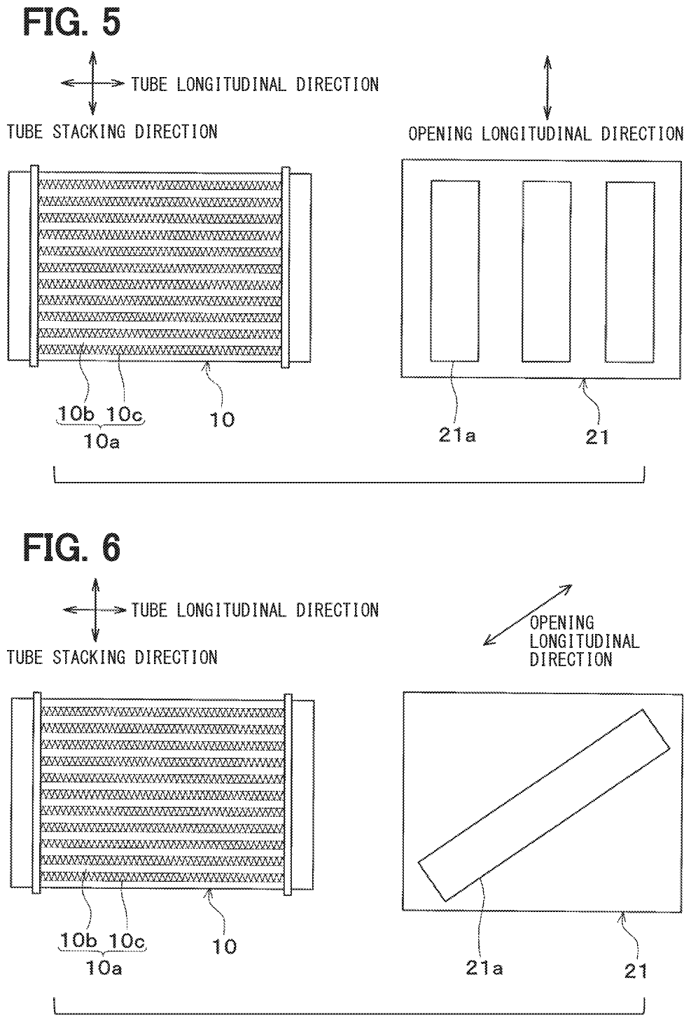

In the present embodiment, the opening 21a of the screen 21 is formed in consideration of a thermal distortion of the heat exchangers 10, 11, which will be described with reference to FIGS. 5 and 6. Only the first heat exchanger 10 is illustrated in FIGS. 5 and 6, and the illustration of the second heat exchanger 11 is omitted FIGS. 5 and 6.

As shown in FIG. 5, the tubes 10b are arranged in the heat exchanger 10 in parallel. If outside air that has passed through the opening 21a of the screen 21 hits only some of the tubes 10b, the temperature difference may increase between the adjacent tubes 10b. When the temperature difference between the adjacent tubes 10b increases, a thermal distortion occurs due to the difference in thermal expansion between the tubes 10b, and the tubes 10b may be damaged.

In this embodiment, the opening 21a of the screen 21 is formed such that the temperature difference between the adjacent tubes 10b is as small as possible. The opening 21a of the present embodiment is designed to form an angle relative to the longitudinal direction of the tube 10b of the heat exchanger 10. In the present embodiment, the opening 21a is rectangular, and the longitudinal direction of the opening 21a is different from the longitudinal direction of the tube 10b.

The longitudinal direction of the opening 21a is not along with the longitudinal direction of the tube 10b, 11b. In the present embodiment, as shown in FIG. 5, the longitudinal direction of the opening 21a is orthogonal to the longitudinal direction of the tube 10b, 11b, and the longitudinal direction of the opening 21a is the same as the stacking direction of the tubes 10b, 11b. Further, as shown in FIG. 6 illustrating a modification of the embodiment, the longitudinal direction of the opening 21a may be oblique to the longitudinal direction of the tube 10b, 11b.

The opening 21a is formed so as to straddle the adjacent tubes 10b, 11b. In the examples shown in FIGS. 5 and 6, the opening 21a is formed so as to extend over all the tubes 10b of the heat exchanger 10, but is not necessarily formed so as to extend over all the tubes 10b.

The opening 21a is formed so that the difference in the amount of air hitting the adjacent tubes 10b, 11b is less than or equal to a predetermined value. In other words, the opening 21a is formed so that the temperature difference between the adjacent tubes 10b, 11b is less than or equal to a predetermined value.

As shown in FIG. 1, the cooling device has a control device 30. The control device 30 includes a known microcomputer with a CPU, a ROM, and a RAM and a peripheral circuit thereof. The control device 30 performs various calculations and processes in accordance with air conditioning control programs stored in the ROM.

A first temperature sensor 31 for detecting the water temperature of the engine cooling water and a second temperature sensor 32 for detecting the water temperature of the inverter cooling water are connected to the input side of the control device 30. The motor 24 is connected to the output side of the control device 30. The control device 30 controls the position of the screen 21 with respect to the heat exchangers 10 and 11 by controlling the motor 24.

The control device 30 controls the operation of the motor 24 in response to the temperature of the engine cooling water detected by the first temperature sensor 31 and the temperature of the inverter cooling water detected by the second temperature sensor 32. Thereby, the position of the screen 21 is adjusted according to the needed cooling amount of the first heat exchanger 10 and the needed cooling amount of the second heat exchanger 11, so as to control the ventilation amount to the first heat exchanger 10 and the second heat exchanger 11.

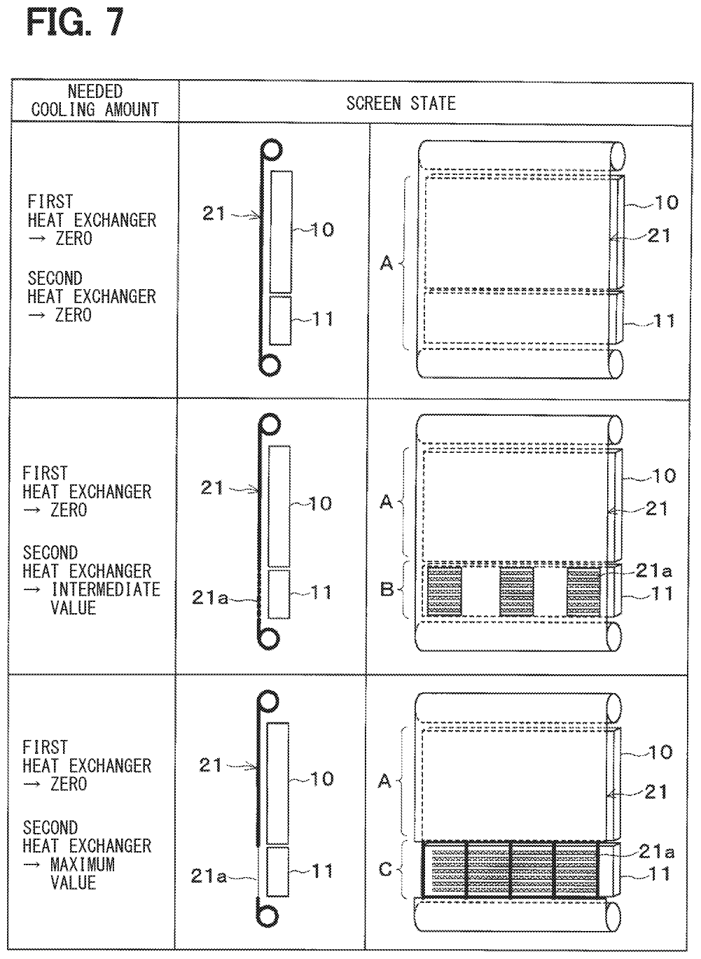

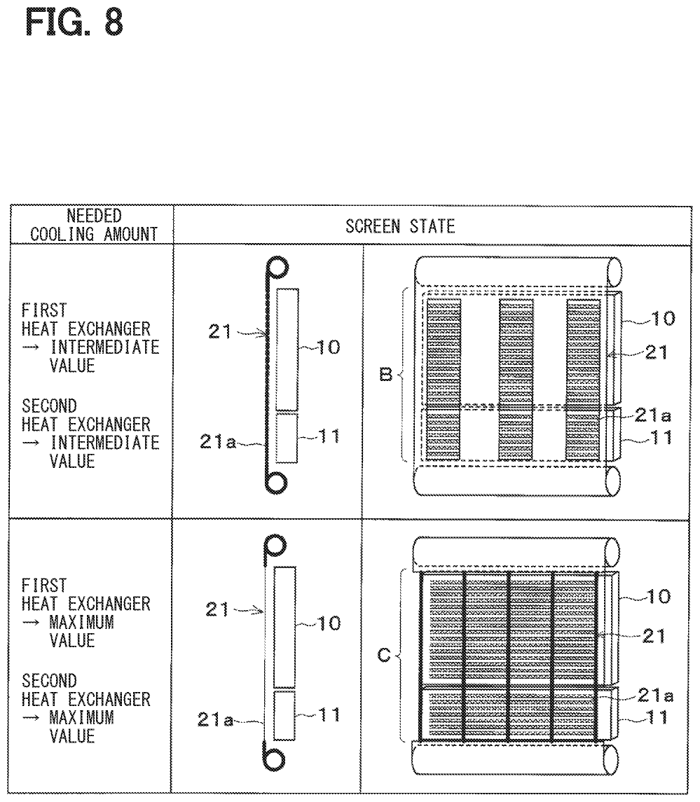

The ventilation amount control of the heat exchangers 10 and 11 will be described with reference to FIGS. 7 and 8. FIGS. 7 and 8 show the relationship between the needed cooling amount of the heat exchanger 10, 11 and the state of the screen 21. The state of the screen 21 shown in FIGS. 7 and 8 is changed by the control device 30 that controls the motor 24.

The upper part of FIG. 7 shows a case where the needed cooling amounts of the first heat exchanger 10 and the second heat exchanger 11 are zero. In this case, the screen 21 is at a position where the closed area A covers the first heat exchanger 10 and the second heat exchanger 11. Therefore, the amount of air flowing through the first heat exchanger 10 and the second heat exchanger 11 is zero.

The middle part of FIG. 7 illustrates a case where the needed cooling amount of the first heat exchanger 10 is zero and the needed cooling amount of the second heat exchanger 11 is an intermediate value. In this case, the closed area A of the screen 21 covers the first heat exchanger 10 and the intermediate open area B covers the second heat exchanger 11. Thus, the first heat exchanger 10 has a ventilation amount of zero, and the second heat exchanger 11 has a ventilation amount of an intermediate value.

The lower part of FIG. 7 illustrates a case where the needed cooling amount of the first heat exchanger 10 is zero and the needed cooling amount of the second heat exchanger 11 is the maximum value. In this case, the closed area A of the screen 21 covers the first heat exchanger 10 and the maximum open area C covers the second heat exchanger 11. For this reason, the ventilation amount of the first heat exchanger 10 is zero, and the ventilation amount of the second heat exchanger 11 is the maximum value.

The upper part of FIG. 8 illustrates a case where the needed cooling amounts of the first heat exchanger 10 and the second heat exchanger 11 are intermediate values. In this case, the screen 21 is located at a position where the intermediate open area B covers the first heat exchanger 10 and the second heat exchanger 11. For this reason, the ventilation amount of the first heat exchanger 10 and the second heat exchanger 11 has an intermediate value.

The lower part of FIG. 8 illustrates a case where the needed cooling amount of the first heat exchanger 10 and the second heat exchanger 11 is the maximum value. In this case, the screen 21 is located at a position where the maximum open area C covers the first heat exchanger 10 and the second heat exchanger 11. Therefore, the ventilation amount of the first heat exchanger 10 and the second heat exchanger 11 has the maximum value.

In the present embodiment, a roll-type shutter device capable of winding and moving the screen 21 is adopted as the shutter device 20 for adjusting the ventilation amount of the heat exchangers 10 and 11. The opening 21a is formed in a part of the screen 21. Thus, only a part of the heat exchangers 10, 11 can be cooled by moving the screen 21 by one motor 24, and the ventilation amount of each heat exchanger 10, 11 can be appropriately adjusted.

According to the shutter device 20 of the present embodiment, the heat exchanger 10, 11 which are not needed to be cooled can be covered with the sheet surface of the screen 21. For this reason, unnecessary outside air is not supplied to the heat exchanger 10, 11, and Cd value can be reduced in most cases. Cd of the Cd value is an abbreviation for Coefficient of drag. The Cd value is an air resistance coefficient. Generally, the smaller the Cd value, the better the fuel efficiency.

Further, in the shutter device 20 of the present embodiment, outside air is supplied to the heat exchangers 10 and 11 through the opening 21a formed in the screen 21. For this reason, it is possible to finely and accurately adjust the ventilation amount of the heat exchanger 10, 11 by providing plural opening patterns different in opening modes such as opening area, opening position, and opening shape of the opening 21a.

Further, in the shutter device 20 of the present embodiment, the opening 21a is formed not along with the tube longitudinal direction, so that the difference in the amount of air hitting the adjacent tubes 10b, 11b is less than or equal to a predetermined value. Accordingly, it is possible to suppress the outside air passing through the opening 21a from hitting only some of the tubes 10b, 11b. As a result, the temperature difference between the adjacent tubes 10b, 11b can be suppressed from increasing, and the occurrence of thermal distortion in the heat exchangers 10 and 11 can be suppressed.

Further, in the shutter device 20 of the present embodiment, the control device 30 controls the winding of the screen 21 by the motor 24 in response to the temperature of the cooling water detected by the temperature sensor 31, 32, so as to control the position of the screen 21 with respect to the heat exchangers 10 and 11. Thereby, the ventilation amount of the heat exchangers 10 and 11 can be appropriately adjusted according to the needed cooling amount of the heat exchangers 10 and 11.

### Second Embodiment

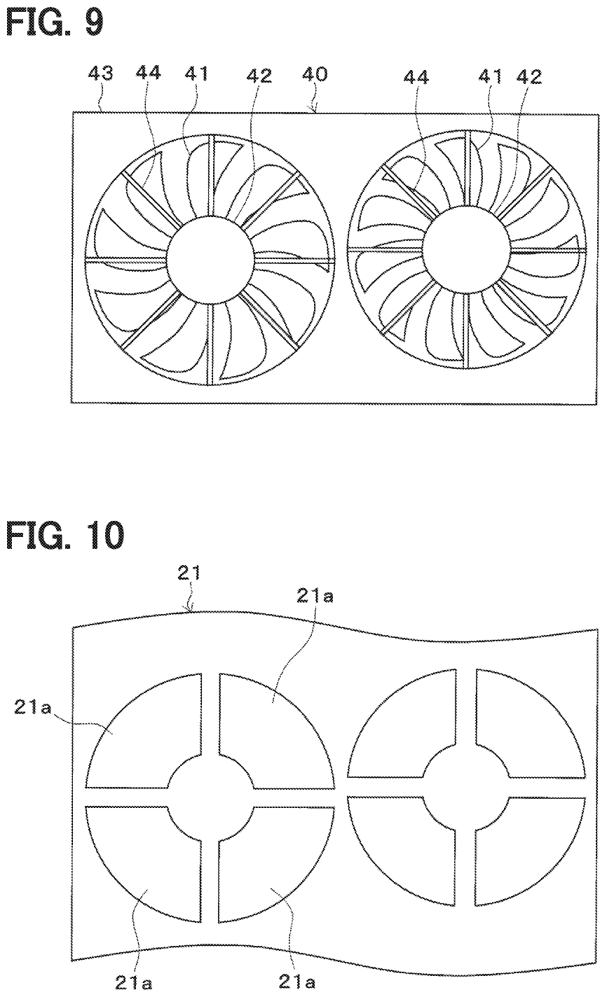

A second embodiment will be described with reference to FIGS. 9 and 10. A description of the same parts as those in the first embodiment will be omitted, and only different parts will be described.

In the first embodiment, the opening 21a is formed in the screen 21 according to the needed cooling amount of the heat exchanger 10, 11. In the second embodiment, the opening 21a of the screen 21 is formed according to the wind speed distribution of the heat exchanger 10, 11.

The cooling device includes a blower 40 shown in FIG. 9. The blower 40 is arranged on the rear side of the heat exchanger 10, 11. The blower 40 includes a fan 41, a fan motor 42, and a shroud 43. In FIG. 9, two sets of the fan 41 and the fan motor 42 are provided.

The fan 41 is an axial-flow fan that blows air, and is configured to rotate around a rotation axis. The fan 41 has plural blades arranged in a circle around the rotation axis. The fan motor 42 is an electric motor that applies rotational power to the fan 41, and the fan 41 is fixed to a rotation shaft of the fan motor 42.

The shroud 43 has a circular opening corresponding to the fan 41. The fan motor 42 is fixed in the opening of the shroud 43 by plural stays 44. The shroud 43 holds the fan motor 42 and guides the air flow so that the air flow induced by the fan 41 passes through the heat exchanger 10, 11.

In the blower 40, an air flow is generated by the fan 41, while an air flow is not generated at the fan motor 42. For this reason, in the heat exchangers 10 and 11, the wind speed at the position corresponding to the fan 41 increases, and the wind speed at the position corresponding to the fan motor 42 decreases. That is, a wind speed distribution is generated in the heat exchangers 10 and 11 by the blowing device 40.

In the second embodiment, the opening 21a of the screen 21 is formed according to the wind speed distribution of the heat exchanger 10, 11. Specifically, the opening 21a of the screen 21 is formed corresponding to a portion of the heat exchanger 10, 11 where the wind speed is higher than or equal to a predetermined value. In the second embodiment, the wind speed is higher than or equal to the predetermined value at a position corresponding to the fan 41 in the heat exchanger 10, 11.

In FIG. 10, the screen 21 has plural sector-shaped openings 21a arranged in a circle. The position and shape of the opening 21a corresponds to the fan 41. The opening 21a is not formed at a position corresponding to the fan motor 42 where the wind speed decreases.

In the second embodiment, the opening 21a of the screen 21 is formed only in a portion of the heat exchanger 10, 11 where the wind speed is high. Thereby, the heat exchangers 10 and 11 can be efficiently cooled while the Cd value is secured.

### Other Embodiments

The present disclosure is not limited to the embodiments described above, and can be variously modified as follows without departing from the gist of the disclosure. Further, means disclosed in the above embodiments may be appropriately combined within a possible range.

(1) In the embodiments, the shutter device 20 is disposed on the front side of the heat exchangers 10 and 11, but is not limited thereto. The shutter device 20 may be disposed on the rear side of the heat exchangers 10 and 11.

(2) In the embodiments, the motor 24 for moving the screen 21 is disposed above the heat exchangers 10 and 11, but is not limited to this. The motor 24 may be disposed below the heat exchangers 10 and 11. Alternatively, the motor 24 may be disposed on the right or left side of the heat exchangers 10, 11. In this case, the screen 21 moves in the left-right direction.

(3) In the embodiments, the screen 21 is moved by rotating the winding unit 22 with the rotary motor 24, but is not limited to this. The screen 21 may be moved using a linear motor that moves linearly.

(4) In the embodiments, radiators for cooling engine cooling water and inverter cooling water of a hybrid vehicle are used as the heat exchangers 10 and 11, and the ventilation amount is controlled with the shutter device 20. The present disclosure may be applied to different heat exchangers. For example, if the vehicle includes a water-cooled intercooler that cools the supercharged air pressurized by the supercharger, a radiator that cools the cooling water that has exchanged heat with the supercharged air may be used as the heat exchanger of the present disclosure. Alternatively, a condenser that condenses the refrigerant of the refrigeration cycle can be used as the heat exchanger of the present disclosure.

The heat exchanger controlled in the ventilation amount with the shutter device 20 may be a combination of heat exchangers through which the same type of heat exchange medium flows (for example, a radiator and a radiator, a condenser and a condenser), or a combination of heat exchangers through which different types of heat exchange media flows (for example, a radiator and a condenser).

(5) In the embodiments, the heat exchangers 10 and 11 controlled in the ventilation amount by the shutter device 20 are stacked in the vertical direction. Alternatively, the heat exchangers may be arranged side by side in the left-right direction.

When the needed cooling amounts of the heat exchangers 10 and 11 are different from each other, the heat exchangers 10 and 11 may be arranged in the front-rear direction. In this case, a heat exchanger having a large needed cooling amount may be arranged on the front side, and a heat exchanger having a small needed cooling amount may be arranged on the rear side.

(6) In the embodiments, the shutter device 20 adjusts the ventilation amount of the plurality of heat exchangers 10 and 11. Alternatively, the shutter device 20 may control the ventilation amount of one heat exchanger. In this case, plural types of heat exchange media may flow through the one heat exchanger or one type of heat exchange media flows through the one heat exchanger.

When plural types of heat exchange media flow through one heat exchanger, the inside of the heat exchanger is partitioned into plural portions, which can be regarded as a configuration in which plural heat exchangers are integrated. In this case, it is only necessary to control the ventilation amount for each part through which different heat exchange media flows.

When one type of heat exchange medium flows through one heat exchanger, if the needed cooling amount is different among plural parts in the heat exchanger, the ventilation amount may be made different among the plural parts. For example, in a typical heat exchanger, the temperature of the cooling water becomes high at the inflow side, and the temperature of the cooling water becomes low at the outflow side. In this case, the ventilation amount is increased on the inflow side of the cooling water and decreased on the outflow side of the cooling water.

What is claimed is:

1. A shutter structure of a heat exchanger for a vehicle comprising:
a screen arranged on a front side or a rear side of the heat exchanger in which heat is exchanged between heat exchange medium and outside air; and
a screen winding unit capable of moving the screen with respect to the heat exchanger by winding the screen, wherein
the heat exchanger is one of a plurality of heat exchangers arranged not to overlap with each other in a front-rear direction of the vehicle, and
an opening is formed in a part of the screen.

2. The shutter structure according to claim 1, wherein the opening has a plurality of opening patterns different from each other to control respective ventilation amounts of the plurality of heat exchangers.

3. The shutter structure according to claim 1, wherein the heat exchange media is different among the plurality of heat exchangers.

4. The shutter structure according to claim 1, wherein
each of the heat exchangers includes a plurality of tubes through which the heat exchange medium flows, and
the opening is formed such that a difference in the amount of air hitting adjacent tubes of the plurality of tubes is less than or equal to a predetermined value.

5. The shutter structure according to claim 1, wherein the amount of air flowing through a part of the heat exchanger corresponding to the opening is able to be controlled by controlling an opening area of the opening.

6. The shutter structure according to claim 1, further comprising:
a blower configured to send outside air to pass through the heat exchanger, wherein a wind speed distribution is generated in the outside air passing through the heat exchanger by operating the blower, and
the opening is formed at a position where a speed of outside air passing through the heat exchanger is higher than or equal to a predetermined value.
